(19) United States
(12) Patent Application Publication
(10) Pub. No.: US 2011/0309593 A1
(43) Pub. Date: Dec. 22, 2011

(54) VEHICLE AND WATT'S LINKAGE THEREFOR

(75) Inventors: Wolfgang Stoff, Wiesbaden (DE); Michael Harder, Bodenheim (DE); Sven Ohligschlaeger, Idstein (DE)

(73) Assignee: GM GLOBAL TECHNOLOGY OPERATIONS LLC, Detroit, MI (US)

(21) Appl. No.: 13/160,605

(22) Filed: Jun. 15, 2011

(30) Foreign Application Priority Data
Jun. 15, 2010 (DE) 102010023808.2

(51) Int. Cl. B60G 21/04

(52) U.S. Cl. 280/124.106

(57) ABSTRACT

A Watt's linkage for the movable connection of two machine parts, in particular a vehicle axle and a vehicle body, includes, but is not limited to two rods, whose ends facing away from one another engage on a first of the machine parts, and a coupling device, which couples the ends of the rods facing toward one another to one another, and is linked on the second machine part. The coupling device includes, but is not limited to two levers pivotable around fixed pivot axes on the second machine part. A first engagement point of the levers is connected in each case to one of the ends of the rods facing toward one another, and second engagement points of the levers are connected to one another by a coupling body, which forces a pivot movement in opposite directions of each of the two levers around their pivot axes.

### CROSS-REFERENCE TO RELATED APPLICATION

This application claims priority to German Patent Application No. DE 102010023808.2, filed Jun. 15, 2010, which is incorporated herein by reference in its entirety.

### TECHNICAL FIELD

The technical field relates to a Watt's linkage and a vehicle which is equipped with such a Watt's linkage.

### BACKGROUND

The usage of Watt's linkages for connecting a vehicle body to its axles, in particular to a non-steered rear axle, has been known for some time. A typical Watt's linkage of the type schematically shown in FIG. 1 comprises, for example, two essentially horizontally situated rods 1, whose ends facing away from one another each engage on a wheel suspension 2 of a vehicle axis. Ends of the rods 1 facing toward one another are connected to one another via a connecting rod 3, which is in turn pivotable around an axis 5, which is fixed on the vehicle body and is perpendicular to the plane of FIG. 1. The Watt's linkage is used for the purpose of guiding a vertical oscillating movement of the wheel 6 of the vehicle relative to its vehicle body 7 exactly linearly in the action direction of shock absorbers 4 situated between the vehicle body 7 and the wheel 6. In addition, it prevents a deviating movement of the vehicle body 7 relative to its wheels in the lateral direction under the influence of a centrifugal force when the vehicle is cornering.

A problem of the typical Watt's linkage is that the rods 1 and the space to be kept free for their movements, as well as support structures 8 which connect the axis of the connecting rod 3 to the vehicle body 7, occupy space under the vehicle body 7 which is required for other installed parts, in particular those which extend, crossing the axle, in the vehicle longitudinal direction, such as parts of the exhaust or tank system. In particular the upper of the two rods, in FIG. 1 the right rod 1, substantially restricts the available space for such installed parts directly below the floor of the vehicle body 7.

Therefore, at least one object is to provide a Watt's linkage or a vehicle having a Watt's linkage, in which such restrictions are at least substantially avoided. In addition, other objects, desirable features and characteristics will become apparent from the subsequent summary and detailed description, and the appended claims, taken in conjunction with the accompanying drawings and this background.

### SUMMARY

The object is achieved in that, in a Watt's linkage for the movable connection of two machine parts, in particular parts of a vehicle, having two rods whose ends facing away from one another engage on a first machine part, and a coupling device, which couples the ends of the rods facing toward one another to one another, on the second machine part, the coupling device comprises two levers pivotable around fixed pivot axes on the second machine part, in each case a first engagement point of the lever being linked on one of the ends of the rods facing toward one another, and second engagement points of the levers being connected to one another by a coupling body, which forces an opposing pivot movement of the two levers around the pivot axes in each case.

To ensure symmetrical behavior of the Watt's linkage under force action, the first engagement points of the two levers and/or the second engagement points, preferably first and second engagement points, each have equal distances to the pivot axes of the levers.

According to a first embodiment, the coupling body can be an elastomeric body, on which both second arms engage so they are pivotable. Through its deformation, the elastomeric body allows the distance change between the two second engagement points, which results from a pivot movement of the levers, to be compensated for. In this first embodiment of the Watt's linkage, the first and second engagement points of the lever each preferably span a right angle with its pivot axis. In this embodiment, if the pivot axes and the second engagement points are on a line in a relaxed state of the elastomeric body, the resistance of the Watt's linkage to a deflection of a first engagement point which is parallel to this line is independent of the direction of the deflection thereof, i.e., the inclination of the vehicle to yield to centrifugal force when cornering is precisely equal in right and left curves.

According to a second embodiment, a coupling rod oriented transversely to the connecting line between the two pivot axes is provided as the coupling element, which engages on the two engagement points of both levers. The coupling rod has the advantage that it allows a deflection movement of the levers without elastic deformation and thus achieves a greater degree of reliability than the first embodiment.

In order to house the coupling rod, the angle spanned by the first and second engagement points of the first lever with its pivot axis is preferably greater than a right angle, and the angle spanned by the first and second engagement points of the second lever with its pivot axis is less than a right angle. Preferably, the angles of the two levers spanned by the engagement points each deviate from the right angle by an equal absolute value. A particularly compact construction is achieved if the coupling rod is perpendicular to the connecting line in a neutral or equilibrium position.

For fine tuning of the Watt's linkage, for example, to compensate for manufacturing tolerances of the dimensions of components of the Watt's linkage or a vehicle body, on which it is installed, the coupling rod can be adjustable in length. A more robust construction can be implemented using a U-profile, which forms a part of the second machine part and has a groove, in which the two levers each engage with pivot axes which cross the groove.

The coupling device allows the rods to be situated in a mirror image to one another, so that when the Watt's linkage is installed in a vehicle, space for further installed parts is provided on both sides of the coupling device in the same way.

A plane, in relation to which the rods are situated in a mirror image, is preferably perpendicular to a connecting line between the two pivot axes. Upon installation of the Watt's linkage in a vehicle, this plane preferably corresponds to its longitudinal central plane. When the Watt's linkage is installed in a vehicle, a wheel axle of the vehicle preferably forms the first machine part and a vehicle body of the vehicle forms the second machine part. The pivot axes of the two levers are preferably at equal height in the vehicle.

In that the first engagement points are situated below the pivot axes, an area directly below the vehicle body can be kept free of the rods and thus made available for other installed parts.

### BRIEF DESCRIPTION OF THE DRAWINGS

The present invention will hereinafter be described in conjunction with the following drawing figures, wherein like numerals denote like elements, and:

FIG. 1 as already discussed, shows a schematic view of a vehicle having a typical Watt's linkage;

FIG. 2 shows a view analogous to FIG. 1 of a vehicle having a Watt's linkage according to a first embodiment;

FIG. 3 shows a view analogous to FIG. 1 of a vehicle having a Watt's linkage according to a second embodiment;

FIG. 4 shows a perspective exploded view of central parts of the Watt's linkage from FIG. 3; and

FIG. 5a to FIG. 5c show schematic views of the Watt's linkage of FIG. 3 each in different relative positions of wheels and vehicle body of the vehicle.

### DETAILED DESCRIPTION

The following detailed description is merely exemplary in nature and is not intended to limit application and uses. Furthermore, there is no intention to be bound by any theory presented in the preceding background or summary or the following detailed description.

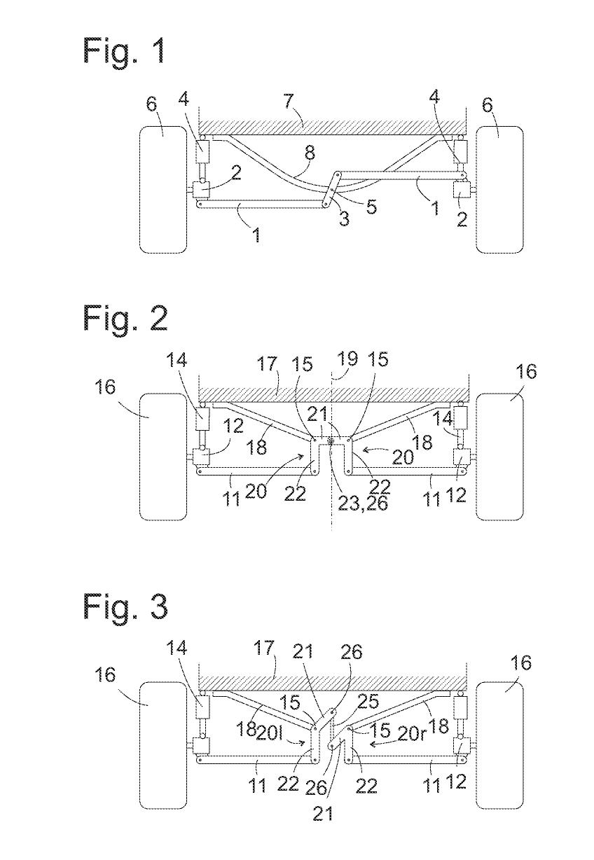

FIG. 2 shows a schematic view of a Watt's linkage according to a first embodiment, viewed in the travel direction of the vehicle on which the Watt's linkage is installed. A support structure 18, which is installed under a floor of a vehicle body 17, fixes pivot axes 15, which extend on both sides of a longitudinal central plane 19 of the vehicle, in the vehicle longitudinal direction. A lever 20 is suspended so it is pivotable around each of these pivot axes 15. The levers 20 each comprise arms 21, 22 which are incident perpendicularly to one another on their respective pivot axes 15. The arms 21 are connected to one another via a pin-shaped elastomeric body 23, which extends transversely to the plane of FIG. 1. Engagement points 26 of the elastomeric body 23 on the arms 21 are formed by holes in the ends of the arms 21 facing toward one another, into which the elastomeric body 23 is inserted. In the configuration of FIG. 2, these holes are aligned with one another and are in the same horizontal plane as the pivot axes 15.

The arms 22 extend vertically upward from the pivot axes 15 and are linked at their lower ends to rods 11 extending horizontally to suspensions 12 of the wheels 16. The suspensions 12 are vertically movable relative to the vehicle body 17 against the force of shock absorbers 14.

When the vehicle body 17 is deflected downward from its neutral position shown in FIG. 2 and the shock absorbers 14 are compressed, the rods 11 each assume an orientation rising from the longitudinal central plane 19 toward the sides. Since the distance of the wheels 16 from one another cannot change due to their contact with the roadway, the arms 22 are drawn outward by the rods 11, the arms 21 are pivoted downward, the holes of the arms 22, which are aligned with one another in the neutral position, move away from one another, and the elastomeric body 23 held in the holes is elastically deformed. The same deflection of the levers 20 and deformation of the elastomeric body 23 occurs if the vehicle body 17 is deflected upward from the equilibrium position and the shock absorbers 24 are extended.

The vehicle body 17 cannot readily yield to a centrifugal force which acts in the lateral direction during cornering, because it would be deflected to the right, for example, in relation to the right wheel 16 in the view of FIG. 2, this would result in a pivot movement of the right lever 20 clockwise and a pivot movement of the left lever 20, which is pulled along via the elastomeric body 23, counterclockwise, by which the left rod 11 and the left wheel 16 would be drawn to the left. However, this is counteracted by the static friction of the left wheel 16 on the ground.

FIG. 3 shows a second embodiment of the Watt's linkage in a view analogous to FIG. 2. The two levers 20 of FIG. 2, which are mirror images of one another, are replaced here by two unequal levers 201, 20r, in one of these levers 20r, the arms 21, 22 spanning an acute angle having the dimensions of approximately 90°−α (In the case shown here, a approximately equal to 45°), while the arms 21, 22 of the other lever 201 span an obtuse angle having the dimension of approximately 90°+α. A coupling rod 25 is linked at engagement points 26 on the ends of the arms 21 of the levers 201, 20r. The pivot axes 15 are at equal height and, in the position shown in FIG. 3, they form a rhomboid or a square together with the engagement points 26.

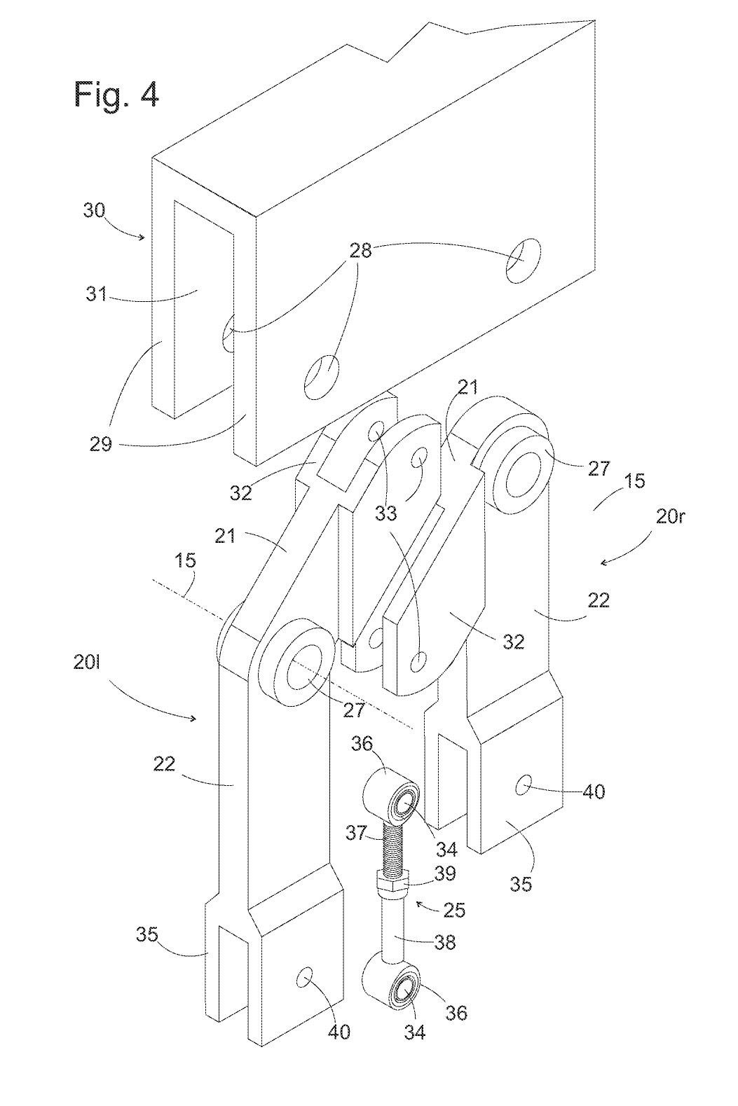

FIG. 4 shows the levers 201, 20r and the coupling rod 25 in an exploded perspective view. The levers 201, 20r each have a collar 27 at the intersection of their arms 21, 22, which is provided to receive an axle journal of the pivot axis 15. The axle journal (not shown) is held in holes 28 inside walls 29 of a U-profile 30, which forms a part of the support structure 18 and is fastened on the bottom side of the vehicle body 17. The arm 21 of the lever 201 which protrudes diagonally upward from the collar 27 is concealed in the installed state in a groove 31, between the side walls 29 of the U-profile 30. The arm 21 of the lever 20r, which is opposite thereto and extends diagonally downward from the collar 27, protrudes downward out of the groove 31 in the assembled state. Forks 32 are formed on each of the ends of the arms 21, in which heads 36, which form the ends of the coupling rod 25, are held with the aid of pins (not shown), which each cross holes 33 of the forks 32 and 34 of the heads 36. The distance of the holes 33 from the pivot axis 15 is equal in both arms 21.

Similar forks 35 as on the ends of the arms 21 are also located on the ends of the arms 22 extending vertically upward, in order to link the rods 11 (not shown in FIG. 4) thereon. These forks 35 are also provided with holes 40, which are to receive a pin connected to heads of the rods 11. The distance of the holes 40 from the pivot axis 15 is also equal in the arms 22.

Of the two heads 36 of the coupling rod 25, one is fixedly connected to a threaded rod 37 and the other is connected to a tube section 38 having internal thread, in which the threaded rod 37 engages. By rotating the heads 36 toward one another around the threaded axis, the length of the coupling rod 25 is settable in steps each corresponding to half of the thread pitch. A nut 39 attached on the threaded rod 37 is locked against the end of the tube section 38, in order to fix the set length of the coupling rod 25.

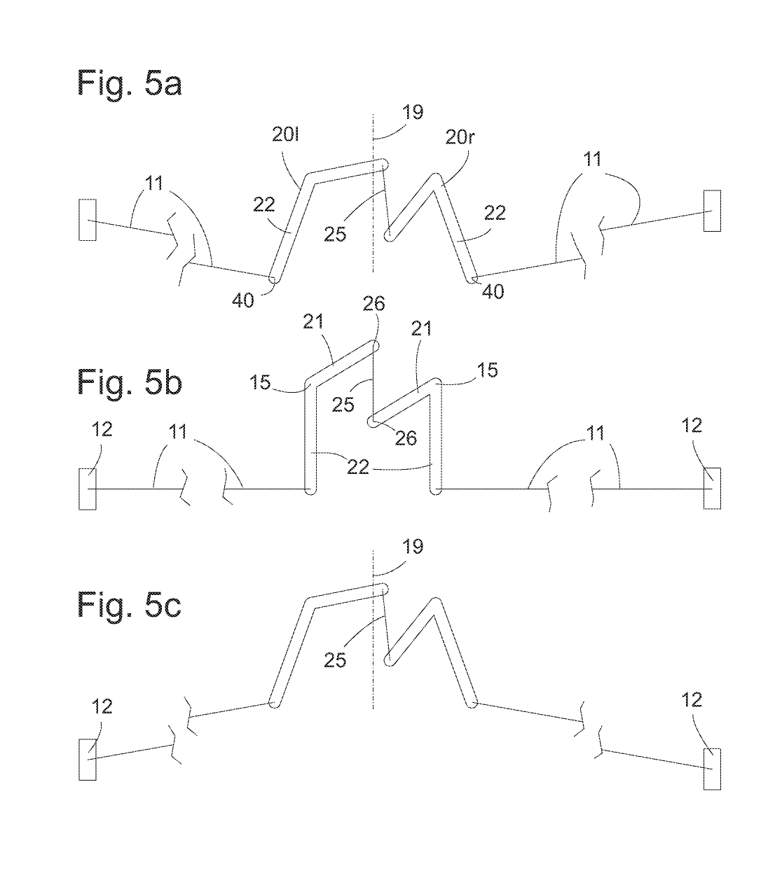

The mode of operation of the Watt's linkage of FIG. 3 and FIG. 4 is illustrated in FIG. 5a to FIG. 5c. FIG. 5b corresponds to the configuration shown in FIG. 3. The two rods 11 extend along an identical horizontal line, the arms 22 are vertical, and the pivot axes 15 and engagement points 26 of the arms 21 form a rhomboid.

When, as shown in FIG. 5a, the wheels 16 are deflected linearly upward relative to the vehicle body 17, the rods 11 slope steeply toward the longitudinal central plane 19. Since the outer ends of the rods 11 engaging on the wheel suspensions 12 are not displaced in the vehicle transverse direction, the engagement points 40 of the rods 11 must be displaced along the arms 22 from the longitudinal central plane 19. The levers 201, 20r are therefore pivoted out of the position shown in FIG. 5b by essentially the same angle, each in the opposite rotational direction.

When the vehicle body 17 is deflected upward from the position corresponding to the configuration of FIG. 5b, the rods 11 each slope steeply outward from the longitudinal central plane 19, as shown in FIG. 5c. Since the wheel suspensions 12 again only move on a vertical line, the engagement points 40 are drawn outward along the longitudinal central plane 19 in precisely the same way as shown in Fig, 5a, i.e., the position of the levers 201, 20r is identical in FIG. 5a and FIG. 5c. As a result, the position of the arms 21 of the lever 201 shown in FIG. 5b is the highest which is achievable during a vertical oscillating movement of the vehicle body. The U-profile 30 therefore does not have to provide a noticeable amount of space to allow a counterclockwise rotation of the arm 21 beyond the position shown in FIG. 5b.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A Watt's linkage for a movable connection of a first machine part and a second machine part, comprising:
a first rod having a first end;
a second rod having a second end facing away from the first end and engage on the first machine part;
a coupling device configured to couple the first end and the second end and linked on the second machine part, the coupling device comprises:
a first lever and a second lever pivotable around fixed pivot axes on the second machine part, in each case a first engagement point of the first lever and the second lever is connected to one of first end or the second end, and second engagement point of the first lever and the second lever connected to one another by a coupling body that forces an opposing pivot movement of each of the first lever and the second lever around the pivot axes.

2. The Watt's linkage according to claim 1, wherein the first engagement point of the second lever are each at substantially equal distances to the pivot axes.

3. The Watt's linkage according to claim 1, wherein the second engagement point of the second lever are each at substantially equal distances to the pivot axes.

4. The Watt's linkage according to claim 1, wherein the coupling body is an elastomeric body.

5. The Watt's linkage according to claim 4, wherein the first engagement point and the second engagement point of a lever span at approximately a right angle with a pivot axis.

6. The Watt's linkage according to claim 1, wherein the coupling body is a coupling rod oriented transversely to a connecting line between two pivot axes and engages on the second engagement point of the first lever and the second lever.

7. The Watt's linkage according to claim 6, wherein a first angle spanned by the first engagement point and the second engagement point of the first lever with a pivot axis is greater than a right angle and a second angle spanned by the first engagement point and the second engagement point of the second lever with a second pivot axis is less than the right angle.

8. The Watt's linkage according to claim 7, wherein angles of the first lever and the second lever spanned by the first engagement point and the second engagement point each deviate by an equal absolute value from the right angle.

9. The Watt's linkage according to claim 6, wherein the coupling rod is substantially perpendicular to the connecting line in an equilibrium position.

10. The Watt's linkage according to claim 6, wherein the coupling rod has an adjustable length.

11. The Watt's linkage according to claim 1,
wherein the second machine part comprises a U-profile,
wherein the first lever and the second lever engage in a groove of the U-profile, and
wherein the two pivot axes cross the groove.

12. The Watt's linkage according to claim 1, wherein the first rod and the second rod are situated in a mirror image to one another.

13. The Watt's linkage according to claim 12, wherein a plane, in relation to which the first rod and the second rod are situated in the mirror image, is substantially perpendicular to a connecting line between the two pivot axes.
